(19) United States
(12) Patent Application Publication
(10) Pub. No.: US 2012/0023188 A1
(43) Pub. Date: Jan. 26, 2012

(54) Private Profile Radio Channel

(76) Inventor: Galaxia L. Martin, Joliet, IL (US)

(21) Appl. No.: 12/905,043

(22) Filed: Oct. 14, 2010

Related U.S. Application Data
(60) Provisional application No. 61/366,932, filed on Jul. 23, 2010.

(51) Int. Cl. G06F 15/16

(52) U.S. Cl. 709/217

(57) ABSTRACT

The device is comprised of an interface that connects or can built into a satellite radio device. The invention includes voice recognition and voice attendant that will communicate back and forth with the user to transmit their request. This device will establish a “Private Radio Profile Channel” within the users radio system to allow instant music downloads based on music providers catalog or music playing on the satellite radio. The profile is able to work with the systems web interface.

This application emanates from a previously filed provisional application No. 61/366,932 filed Jul. 23, 2010.

### FIELD OF THE INVENTION

The present invention relates in general to the field of digital transmission of digital content, and more particularly, to a system and method for interacting with the transmitting and exchanging payment information for digital radio content.

### BACKGROUND OF THE INVENTION

Digital radio, or digital audio broadcasting (DAB), is a method for transmitting digital quality audio signals to digital radio receivers. In-Band On-Channel (IBOC) transmission is a broadcasting technology characterized by the transmission of digital signals in the existing AM and FM spectrum and according to existing station assignments. A digital radio transmission scheme that uses IBOC transmission can be expected to deliver compact disc quality sound at the existing FM radio dial positions. Similarly, a digital radio system that uses IBOC transmission for AM radio can be expected to deliver FM quality sound

Advantages of digital transmission for audio include better improved quality, less noise, and, a wider dynamic range, as compared with existing AM and FM radio. In addition to improved audio quality, IBOC digital audio broadcasting also provides for the transmission of data. Although FM subcarriers are now used to deliver data for many applications, IBOC digital audio broadcasting subsystems can accommodate larger amounts of data with greater reliability. Furthermore, prior to IBOC digital audio broadcasting, there has been no such capability in the AM band. Since the data may be audio or video, potential applications for data include station data such as call sign, format, artists and song titles, as well as music videos, images, news, financial and stock market data, paging, e-mail, dispatching, computer communications, and networking However, digital radio still possesses some of the shortcomings of traditional AM/FM radio. The user of a digital radio receiver can listen to or view the content of a digital radio transmission only at the time the content is being broadcast and only in the location where the user has physically placed the digital radio receiver. Not only is the user of a digital radio receiver limited in terms of the location in which he may listen to or view digital radio content, but he may only hear or view a portion of the available content depending on the time when he tunes his receiver to the selected channel. These shortcomings can be addressed by exploiting the advantages presented by digital radio's use of a digital, rather than analog, signal, namely, the ease of transmitting and storing digital information or content.

With the development of digital transmission and storage of music, video and other content, the ability to manipulate, select and store or download such digital content is in high demand.

The current device will improve the way we listen to such digital music. It will essentially replace the need for SD cards, mp3 players, or any similar one-feature device for usage in a vehicle to listen to portable music. All of your music will be listened through your profile channel. It will enable a “going green” aspect to the music industry by limiting the numbers of distributed hard-copied music. Therefore it will limit the amount of pollution caused from the production of the product and cut costs down.

### SUMMARY OF THE INVENTION

The device includes an interface that connects or can built into a satellite radio device. It includes voice recognition and voice attendant that will communicate back and forth with the user to transmit their request. This device will establish a “Private Radio Profile Channel” within the users radio system to allow instant music downloads based on music providers catalog or music playing on the satellite radio. The profile is able to work with the systems web interface.

The device I have invented will work as the following: If a user hears a song that they want on their satellite radio, it will be possible to use this device by voice recognition/voice attendant and state several words such as “purchase” which then downloads the file, or “Song title” which then in return informs you via voice attendant the song title, “Artist name”, which then in return informs you via voice attendant the artist name. There are other words that could be integrated into this device as well. Once the file is downloaded, you can organize, setup play list, delete, or play file from your “Private Radio Profile Channel” via voice recognition. This device allows hands free listening and downloading of music via automobile by establishing the users private profile channel. This function's intention is to be an addition to satellite radio. It will allow users to use a web interface via their home computer or mobile application to also organize, delete, download, upload, or play songs if the user chooses to do so. The web feature will be a basic music player design and will allow the user to have their files sent to their computer or files sent to the web interface. The function intends to work with music kiosks within stores that will also allow music to be purchased and downloaded then sync to their profile device via satellite. Therefore the user will be able to listen to their own music and purchased music to their profile channel on their radio. Since this device will be used with an existing satellite radio setup, the user will still have subscription fees, the user will also be charged for this private profile channel service.

The concept is to store the users private profile channel via the systems web interface/web environment, similar to establishing a “music account,” which in return the user will be charge per amount of downloads and storage used. The private radio profile channel will allow complete control of music for one location and convenience, instead of using SD Cards, CD's, or MP3 players.

### BRIEF DESCRIPTION OF DRAWINGS

FIG. 1 is the frontal view of the device

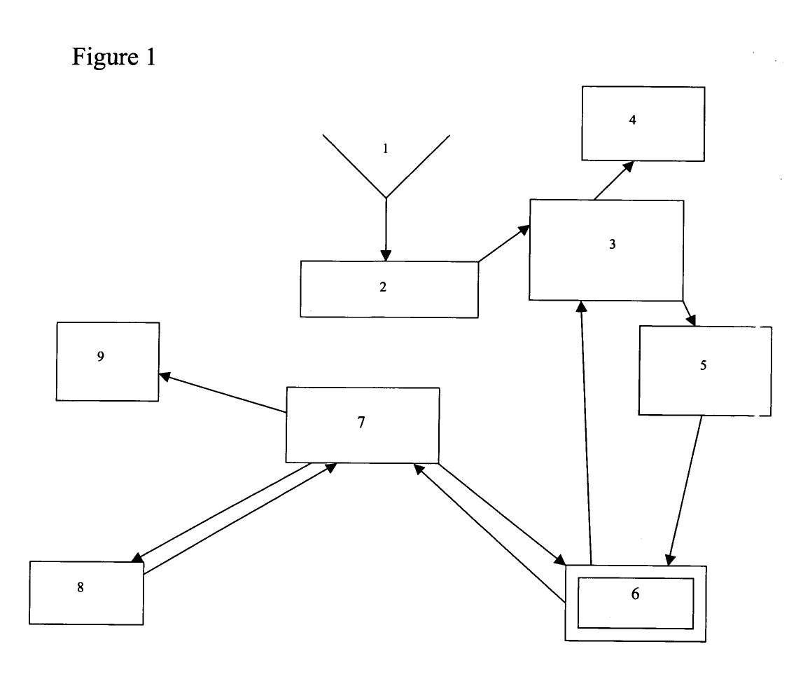

### DETAILED DESCRIPTION

Diagram Key

1. Satellite Radio

2. Existing Client Satellite Radio Device

3. Private Radio Profile Channel (PRPC) Device with Voice Recognition

4. Clients has either use voice recognition or manually tune to the specified to Channel number to use on their private radio profile for Satellite Radio

5. Voice recognition to download, organize, and play music on the profile channel from music that is played on the satellite radio stations or within a purchase catalog library

6. Hosting Server Location

7. Web Interface Server

8. Store Kiosks to purchase & download

9. Client's home computer or Mobile Device will have the ability via web interface server to upload, download files to profile channel

Diagram Explanation

All download requests will be transferred back and forth through satellite network to the profile device. The web interface server/hosting server data transfer rate will be faster data speed then satellite. Multiple profile channels can exist with one profile device, because the information is not stored on the device, but communicated back and forth to the hosting servers where the client's information is stored. The Private Radio Profile Device allows the transmission and voice recognition communication to occur for the client's requests, and then sends it to the hosting server location; then back to the Private Radio Profile Device for recognition to the clients profile channel. The hosting server location will also communicate to the web interface to make everything updated s for at home and mobile application use. The store kiosks will communicate through the web interface server, and then back to the hosting server location, then to the Private Radio Profile Device, then to the private channel.

I claim:

1. A private profile radio channel which embodies programming for the purpose of downloading music on any satellite radio station and in the provided catalog.

2. A private profile radio channel, comprising:
remotely activating a digital storage, in a computer memory within a computer system, a database comprising a plurality of pieces of music;
providing a digital communications network between the computer system and a remote device of the user so that the user communicates with the computer system over the communications network;
to add or retrieve a piece of music from the database; and
transmitting the piece of music to the remote device over the communications network.

3. The private profile radio channel device of claim 1 wherein the device has a personal radio profile channel where the user can organize playlists, and initializing play and next is features

4. The private profile radio channel device of claim 1 wherein the device has a voice attendant for downloading music, organizing playlists, and initializing play, next, etc.

5. The private profile radio channel device of claim 1 wherein the device has a web interface for users to use on their computers.

6. The private profile radio channel device of claim 1 wherein the devices web interface that allows downloading, organizing music, playlists, and uploading end users own music.

7. The private profile radio channel device of claim 1 wherein the devices web interface is linked to the personal radio profile channel, and will allow automatic syncing from web interface to car and/or mobile device.

8. The private profile radio channel device of claim 1 wherein the device allows in store music purchases via web interface via in store kiosks, and eliminates the need for hard copies of music.

9. The private profile radio channel device of claim 1 wherein the device supports the go green environment by allowing in store downloads and saving costs on production of music hard copies.

10. A private profile radio channel whereas digital media is uploaded and stored via private user interaction for future or immediate storage or play on a user selected digital channel comprising software and hardware to be added to an existing digital radio device.
